(19) United States
(12) Patent Application Publication
(10) Pub. No.: US 2025/0307029 A1
(43) Pub. Date: Oct. 2, 2025

(54) WORKLOAD REALLOCATION IN HIERARCHICAL MEMORY ARCHITECTURES

(71) Applicant: Unisys Corporation, Blue Bell, PA (US)

(72) Inventors: Andrew Ward BEALE, Carolina Shores, NC (US); David Strong, Irvine, CA (US)

(21) Appl. No.: 18/618,615

(22) Filed: Mar. 27, 2024

(51) Int. Cl. G06F 9/50

(52) U.S. Cl. CPC G06F 9/5088; G06F 9/5016; G06F 9/5077

(57) ABSTRACT

Dynamic workload relocation minimizes operational downtime, during system upgrades and updates, by relocating workloads between execution environments. A workload is quiesced to move its memory image from one encompassing environment to another. Once quiesced, a custom bootstrap is created within the workload's memory image to allow a different processor to boot into the existing environment. The bootstrap retains the information contained within the relocated memory image instead of reinitializing memory as in a normal bootstrap process. The workload is quickly resumed since all of its state was relocated, and the interruption to the users of the workload is minimized, while potentially obtaining upgrades or updates during the relocation process. Once resumed, the original environment is now free to be serviced in a manner that allows sufficient time to test and validate that the service was successfully completed without a significant interruption to the workload which was active at the time.

### BACKGROUND

Servers host operating environments that execute software programs. These software programs can be accessed and used by clients. When aspects of an operating environment need to be updated or rebooted, clients often cannot perform the functions provided by the programs during the update or reboot timeframe.

### SUMMARY

Dynamic workload reallocation allows workloads providing client services to be dynamically moved across operating environments so that client systems do not experience downtime caused by the updates or reboots of the operating environment.

A first operating environment that a first memory component storing a plurality of workloads that each provides a client service can be employed. The first memory component can have a first contiguous address range that defines its storage space. Each of the workloads can have a separate address region within the contiguous address range in which each workload is stored.

If aspects, such as firmware or software, of the first operating environment need to be updated, this may require the first operating environment to be rebooted to implement the updates. So that the client using the first workload does not experience downtime during the updates, the first workload can be moved to a second operating environment that has a second memory component.

To do so, an address region within the second memory component is identified. The first workload is quiesced, for instance, by pausing its input/output (I/O) operations. A bootstrap stack can be at least partially built and a processor emulator cloned from a first workload processor emulator executing the first workload within the first memory component. The first workload is replicated within the identified address region of the second memory component. At the second memory component, the operations are resumed using the cloned processor emulator and the bootstrap stack. With operations of the first workload now running within the second operating environment, the first operating environment can be updated and rebooted. In this way, the first workload may continuously provide services to client systems, even when operating environments are down.

This summary is intended to introduce a selection of concepts in a simplified form that is further described in the Detailed Description section of this disclosure. The Summary is not intended to identify key or essential features of the claimed subject matter, nor is it intended to be an aid in determining the scope of the claimed subject matter. Additional objects, advantages, and novel features of the technology will be set forth in part in the description that follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is an example general operating environment suitable for dynamically relocating workloads between operating environments, in accordance with an aspect described herein;

FIG. 2 illustrates an example first operating environment having a plurality of workloads running therefrom, in accordance with an aspect described herein;

FIG. 3 illustrates the example first operating environment of FIG. 2 and an example second operating environment suitable for running workloads therefrom, in accordance with an aspect described herein;

FIG. 4 illustrates an example in which a first workload is moved from the first operating environment to the second operating environment, in accordance with an aspect described herein;

FIG. 5 illustrates an example method of dynamically moving a workload between operating environments, in accordance with an aspect described herein;

FIG. 6 illustrates another example method of dynamically moving a workload between operating environments, in accordance with an aspect described herein; and

FIG. 7 illustrates an example computing device that may execute operations for dynamically moving workloads between operating environments, in accordance with an aspect described herein.

### DETAILED DESCRIPTION

In today's commodity computing operating environments, there are many instances where an update results in the need for a reboot, whether to enable a new software or correct performance issues. This type of interruption, and others, can cause downtime for client services running operations from the operating environments.

Recognizing that clients might experience downtime during certain maintenance events, service providers have historically scheduled system updates during off-peak hours to try to minimize the disruptive impact that a client employing their resources might experience. By scheduling downtimes, the operating systems hosting these services could be updated, rebooted, and the services restarted during times where there is minimal impact during the downtime. Oftentimes, this must be scheduled with clients in advance to further minimize the impact of the service downtime. However, in many cases, clients may employ a remote service around the clock, meaning that there is no convenient system downtime.

To alleviate system downtime when employing remote computing or software services, the technology described herein provides for dynamic workload movement between memory systems. Here, workloads providing services can be moved between memory components employed by different operating environments. As such, if one operating environment is to undergo maintenance or may become offline for another reason, then workloads providing client services can be moved to another memory component of another operating environment in a manner that allows the client service to be continually provided. In this way, maintenance, such as updates that require system reboots, may be performed with minimal to no service downtime.

There are other benefits to employing the workload movement method described herein. For instance, workloads can be moved to operating environments hosted by servers in different geographical areas. This could allow the workload to be moved from systems that may be impacted by particular events, such as weather hazards. Further, moving the workload geographically allows a host service provider to take advantage of demand and power consumption efficiencies that differ between regions. For example, it may be nighttime in one region, and as such, networks and servers in that region are experiencing lower demand. By moving the workloads to be processed by servers in regions with lower demand makes it less likely that demand spikes will interfere with the network or processors, thus providing for more consistent and stable services. Once the demand begins to increase, the workloads may be moved back or to another region with lower demand once again. Further, the cost of power consumption varies between geographic regions and regularly changes based on any number of factors. Thus, these lower-cost regions may be identified and the workload moved so that they are hosted by servers in the lower-cost regions. In all, the technology provides methods to dynamically move workloads without significant service interruptions, thus allowing a service provider to advantageously utilize various geographical regions.

To achieve these benefits and more, workloads providing client services can be moved to different memory components within operating environments in a manner that limits service downtime. In one example, a first operating environment comprising a first memory component is employed. The first operating environment comprises a first memory component, and the first memory component has a contiguous address range that defines the storage space of the memory component.

The first memory component of the first operating environment stores a plurality of workloads. Each workload can provided one or more client services, ranging from a simple print command to more complex services that process large volumes of I/O operations. Here, each workload is stored within a separate address region within the contiguous address range of the first memory component. To provide services, workloads can each correspond to a processor emulator that executes the functions of a workload to provide the respective service. As such, the first workload uses a first processor emulator to provide it services. In this way, the various workloads are provided using the emulated workload environments stored within each region of the first memory component.

The first workload may be moved to a second memory component of a second operating environment and then run from the second memory component. The second memory component can also have a contiguous address range that defines its storage space. Thus, an address region within the second memory component can be identified within the contiguous address range. This identified address region may be identified based on it having the same memory size as the address region for the first workload within the first memory component.

To move the first workload to the second memory component, the first workload at the first memory component can be quiesced. For instance, its I/O operations may be paused when quiesced. For example, when pausing I/O operations, all outstanding I/O operations may be completed. The I/O operations may be quiesced once the outstanding I/O operations are completed. As will be described, when reinstantiated at the new location, I/O operations that were previously queued can then be initiated and completed normally.

A bootstrap stack can be built from the first workload. As noted, the first workload may be executed by a first processor emulator. Various emulation architectures may have other components, including additional processor emulators, that initialize or perform aspects of a workload. Further, the first processor emulator and any other components can be cloned or otherwise instantiated. The bootstrap stack in this example may be executed at least a processor emulator cloned from the first processor emulator and any other cloned components for executing functions of the first operating environment. In an aspect, the cloned processor emulator is compiled to execute at different processor of the second operating environment relative to the first operating environment, such an x64 versus ARM environment.

Having built the bootstrap stack for the first workload, the first workload can be replicated within the identified address region of the second memory component. From the second memory component, the first workload can be resumed by initializing the bootstrap stack. Thus, the first workload can be resumed by resuming the I/O operations paused during the quiescing by resuming a scheduler and executing the operations using the processor emulator.

The building of the bootstrap stack and replicating the first workload within the second memory component are relatively fast operations. Thus, the services provided to a client device by using the first workload may experience only a momentary pause, which will not be noticeable in some cases.

Now that the first workload is being executed from the second memory component, the first operating environment may be updated, including hardware, software, firmware, or another system component, without a major interruption of service provided by the first workload. If needed, the first operating environment may be rebooted to initialize the new updates, still without the client device experiencing a corresponding service interruption. If desired, the first workload could be moved back to a new address region within the first memory component, which may be the same or a different address region than the prior address region occupied by the first workload, after any updates and reboot.

In another example use case, the first workload is moved to a second operating environment hosted by a server in a different geographical location. The first workload may remain at the second memory component for any duration of time. The first workload may be subsequently moved to the same or another geographical location at a subsequent time.

The dynamic workload movement technology improves computing devices relative to those employing existing methods. As noted, it has been a common practice to schedule downtime for remote hardware or software services to perform updates to the systems and operating environments providing such services. However, it has not been a routine practice in the field to dynamically move workloads using the described methods to avoid this type of downtime altogether. Further, it has not been a routine practice to move workloads to servers based on the geography of those servers in a manner that limits or eliminates system downtime.

These methods are believed to benefit and advance computing technology. In particular, by dynamically moving workloads to different operating environments, the downtime experienced by systems employing the remote services is reduced or eliminated. Moreover, the technology provides further benefits to server or operating environment maintenance. That is, system hardware can be updated or replaced, firmware and software can be updated, and systems can be rebooted or isolated all while continuously providing remote computing or software services to client devices.

It will be realized that the method previously described is only an example that can be practiced from the description that follows, and it is provided to more easily understand the technology and recognize its benefits. Additional examples are now described with reference to the figures.

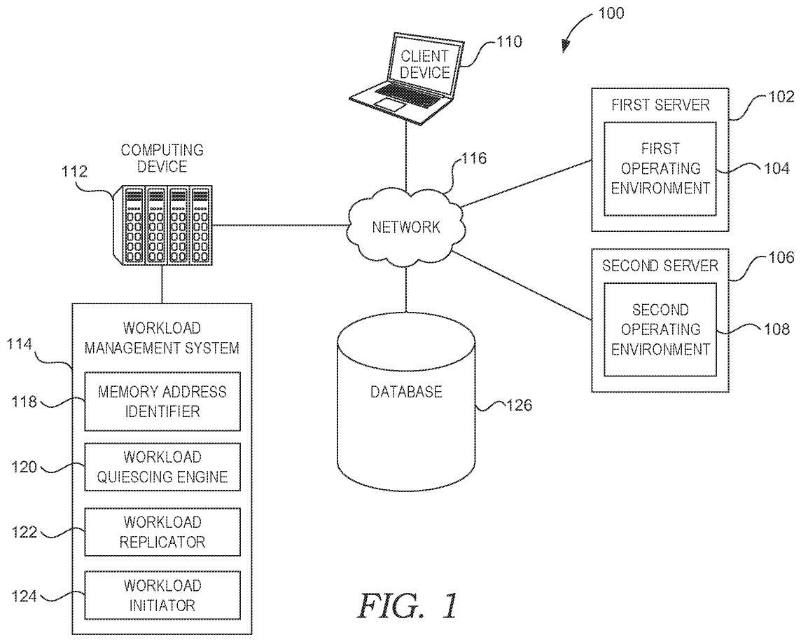

With reference now to FIG. 1, an example general operating environment 100 in which aspects of the technology may be employed is provided. Among other components or engines not shown, general operating environment 100 comprises first server 102 that hosts first operating environment 104 and second server 106 that hosts second operating environment 108.

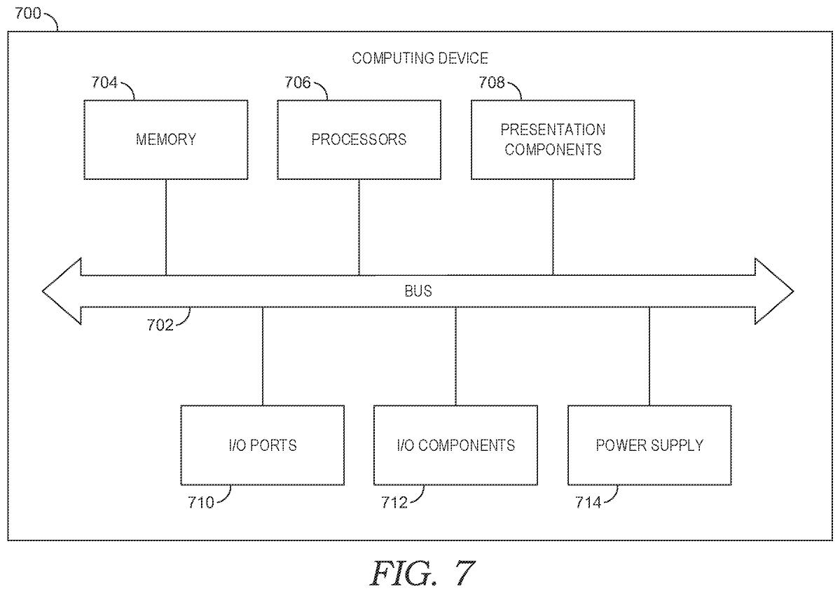

FIG. 1 further depicts client device 110, which may be remote from and utilized by the services provided by first server 102 or second server 106. This may include a wide variety of one or more services, including simple commands to services having large volume I/O processes. Generally, client device 110 is a computing device, an example of which is provided with respect to FIG. 7.

To prevent disruption in the services provided to client device 110, computing device 112 may employ workload management system 114 to dynamically move workloads between first operating environment 104 and second operating environment 108. An example computing device suitable for use as computing device 112 is provided by FIG. 7.

Each of the components of FIG. 1 are illustrated as communicating via network 116. Generally, network 116 may include one or more networks (e.g., public network or virtual private network [VPN]), as shown with network 116. Network 116 may include, without limitation, one or more local area networks (LANs), wide area networks (WANs), or any other communication network or method.

Workload management system 114 provides computer functions that may be written to or otherwise may access database 126 to move the workloads. Generally, database 126 stores information, including data, computer instructions (e.g., software program instructions, routines, or services), or models used in embodiments of the described technologies. Although depicted as a single database component, database 126 may be embodied as one or more databases or may be in the cloud. In aspects, database 126 is representative of a distributed ledger network.

Referring back to first server 102 and second server 106, in the example illustrated by FIG. 1, these are separate and distinct servers that each respectively hosts first operating environment 104 and second operating environment 108. Each server may host one or more operating environments. Thus, first server 102 could host first operating environment 104 in addition to another operating environment. Similarly, second server 106 could host second operating environment 108 in addition to another operating environment. While illustrated as having two servers, the technology could have any number of servers hosting any number of operating environments. Moreover, in yet another arrangement, first server 102 may host both first operating environment 104 and second operating environment 108.

A server, such as first server 102 and second server 106, is a computer that provides services, including data and resources, over workload management system 114 to client device 110. An example computing device is provided by FIG. 7. A server can range from a single dedicated machine to an arrangement of multiple interconnected devices working together to provide the shared services. As such, while first server 102 and second server 106 are each illustrated as a single component, each may include one or more machines for hosting the operating environments. In an aspect, first server 102 and second server 106 are located within different geographical regions.

It is again noted that the illustrated general operating environment 100 provided by FIG. 1 is only an example. For instance, one or more devices and arrangements may perform the functions described with respect to those performed by first server 102, second server 106, client device 110, and computing device 112. There are different arrangements of hardware systems and software functionality, and it is impractical to illustrate and describe them all. Thus, the present description is meant only to provide an example implementation and arrangement of the technology, and other implementations and arrangements will be recognized by those having ordinary skill in the art.

Having this in mind, the example workload management system 114 may be used to dynamically move workloads between operating environments, such as first operating environment 104 and second operating environment 108. An example operating environment, such as first operating environment 104 and second operating environment 108, includes an operating system and memory resources. The operating system may manage hardware interactions, run applications, organize data storage and retrieval, and so forth, in the memory resources. One advantage of the technology is that the operating environment may run one of several different types of operating systems, such as Window, Linux, MacOS, or another type of operating system as a primary operating system, which are generally used to host the firmware.

The operating environment includes memory, also referred to as a memory component, that may store one or more workloads. As an example, the memory component may include RAM (random-access memory), virtual memory, or the like, such that the memory comprises a contiguous address range in which to store data. In general, memory can be organized as a set of linear addresses, from 0 to N, of any given width based on the organization of the architecture on which it runs. Memory may be measured in terabytes (TB), petabytes (PB), and beyond in some implementations. As an example, a memory component might be 4 TB. As such, the contiguous address range may extend from 0 to 250 bytes RAM. As will be understood, memory components may have a broad range of storage capabilities, and as such, this example is only one out of many possibilities and is not meant to limit the technology to a particular memory size or arrangement.

Each workload may provide one or more services to a client device, such as client device 110, and may be stored to separate address regions of the operating environment memory. An example workload can be defined to include its own programs, libraries, data, and so forth. A workload can have a processor emulator, including combinations of various processors, for carrying out the tasks of the workload. Thus, each workload may emulate an operating system that may be the same as or different from the operating system of the operating environment. Advantageously, this allows workloads to provide services to devices running different types of operating systems, yet all be hosted by the same operating environment. Moreover, since workloads can be run using a processor emulator, the workload may be transferred between memory of operating environments that also use different operating systems, thus allowing for great flexibility when moving workloads between operating environments and servers hosting those operating environments.

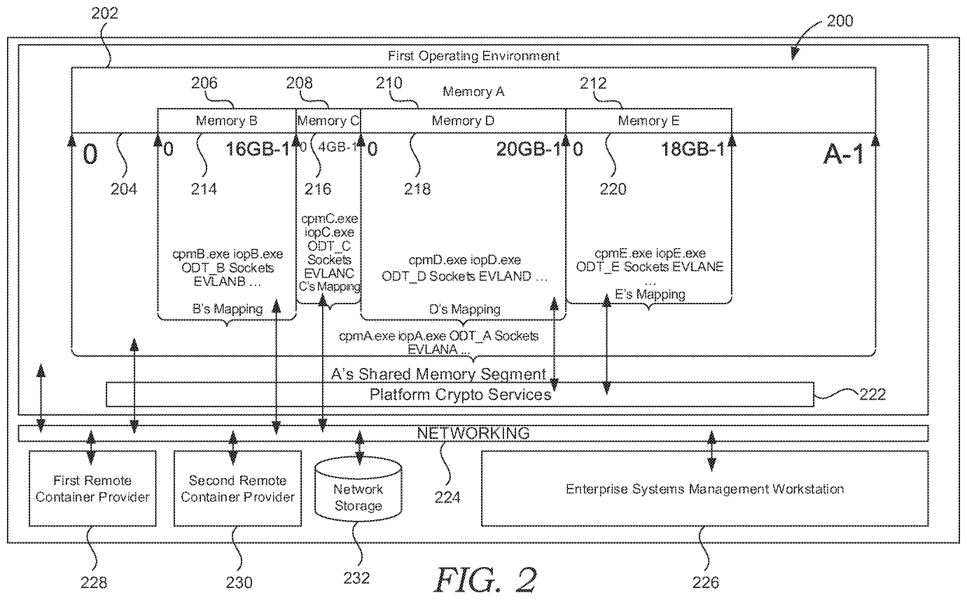

FIG. 2 illustrates an example first operating environment 200. First operating environment 200 illustrates an example operating environment and may correspond to a first operating environment suitable for use as first operating environment 104 of FIG. 1.

In general, first operating environment 200 generally includes a system architecture, such as x64 (also known as x86-64) and ARM (Advanced RISC Machine). First operating environment 200 could include other RISC (Reduced Instruction Set Computing), CISC (Complex Instruction Set Computing), or other like architectures, such as Power ISA (Instruction Set Architecture) and MIPS (Microprocessor without Interlocked Pipelined Stages).

First operating environment 200 may run an operating system within its system architecture. For instance, the operating system may run a Windows, Linux, MacOS, BSD (Berkeley Software Distribution), or the like. First operating environment 200 includes the firmware, e.g., BIOS (Basic Input/Output System), UEFI (Uniform Extensible Firmware Interface), and other resources compatible with the operating system.

As illustrated, first operating environment 200 comprises memory A 202. This may be the primary memory component of first operating environment 200 and may store a plurality of workloads that each provide one or more client services. Memory A 202 stores the workloads over contiguous address range A 204, shown extending from 0 to A−1. Thus, for instance, if the memory A 202 were 4 TB, then the contiguous address ranges in bytes from 0 to 2⁴²−1. Each of the plurality of workloads is stored in a separate address region within memory A 202.

In an aspect, the memory A 202 is included as part of an emulated environment. The emulated environment is responsible for managing additional emulated environments that each correspond to a workload within the plurality of workloads. In this aspect, each workload is another emulated environment, where services are executed directly from each emulated environment using processor emulators corresponding to each of the workloads.

In the example of this illustrated in FIG. 2, four workloads are operating within memory A 202, including first workload 206, second workload 208, third workload 210, and fourth workload 212. While illustrated as four workloads, there may be any number of one or more workloads executed from a memory component of an operating environment. In a particular case, memory component, such as memory A 202 may be configured to store workloads executable from the component. However, at a given time, there may be no workloads stored with the memory component. Here, each workload is stored and executed from an address region of memory A 202. The address region may include a consecutive and separate address region within memory A 202. As illustrated, first workload 206 uses 16 GB (gigabytes) of memory, second workload 208 uses 4 GB of memory, third workload 210 uses 20 GB of memory, and a fourth workload 212 uses 18 GB of memory. Thus, first workload 206 is stored within address region B 214 of contiguous address range A 204, which is designated Memory B in the illustration. Second workload 208 is stored within address region C 216 of contiguous address range A 204, which is designated Memory C. Third workload 210 is stored within address region D 218 of contiguous address range A 204, which is designated Memory D. Fourth workload 212 is stored within address region E 220 of contiguous address range A 204, which is designated Memory E. Moreover, each of the one or more workloads may be wholly contained within Memory A or it may have connections with other entities via networking, named pipes, shared memory areas, etc. which also participate in the workload.

In an aspect, each workload is stored in consecutive memory regions. For example, if first workload 206 is stored at an address location corresponding to 4 GB, then it extends to the address location corresponding to 20-1 GB. Second workload 208 may then extend from 20 GB to 24-1 GB, and so forth with third workload 210, fourth workload 212, and other workloads.

As noted, each workload may correspond to its own individual processor, thus providing multiple emulated environments within first operating environment 200. Advantageously, workloads may provide services to client devices running different operating systems, and workloads within first operating environment 200 may run different emulated operating systems, whether the same or different than the one running on memory A 202. This also allows workloads to be easily moved to different operating environments running different operating systems. As such, each workload in this example includes at least one processor emulator, illustrated here as cpmB.exe and iopB.exe, cpmC.exe and iopC.exe, and so forth. In this example, cpm and iop respectively correspond to instruction and I/O processor emulators. The processors cpmA.exe and iopA.exe correspond to the emulated environment executing from memory A 202 and may be used to manage the workloads themselves, such as the stored location of the workloads, or other functions for moving the workloads, as will be described. As described, a processor emulator is intended to include any one or more emulators that execute functions. Various systems may combine or split functions between processors, and such systems are intended to be within the scope of this disclosure and described with reference to the processor emulator.

First operating environment 200 may coordinate with other components to provide services via the plurality of workloads. In the example environment of FIG. 2, each of the plurality of workloads, first workload 206, second workload 208, third workload 210, fourth workload 212, and memory A 202 each communicates through cryptography services tunnel 222 to a third-party cryptography service to provide secure communications with external machines, such as client device 110. FIG. 2 provides only one example, and other arrangements may be used to provide cryptography services or other alternative services.

Further, in the example illustrated, components of memory A 202, including first workload 206, second workload 208, third workload 210, and fourth workload 212, communicate via network 224. Network 116 is an example suitable for use as network 224.

In the example of FIG. 2, components of first operating environment 200 communicate with first remote container server 228 and second remote container server 230. The container platform is one example tool for automating application deployment in lightweight containers so that applications can work efficiently in different isolated environments.

Additionally, in the FIG. 2 example, first operating environment 200 communicates with systems management workstation 226 via network 224, which may access storage 232. In general, systems management workstation 226 can be provided to facilitate and manage the dynamic movement of workloads, such as first workload 206, second workload 208, third workload 210, and fourth workload 212, to other operating environments, such as second operating environment 108, as will be further described. In an aspect, systems management workstation 226 employs functions described with reference to workload management system 114.

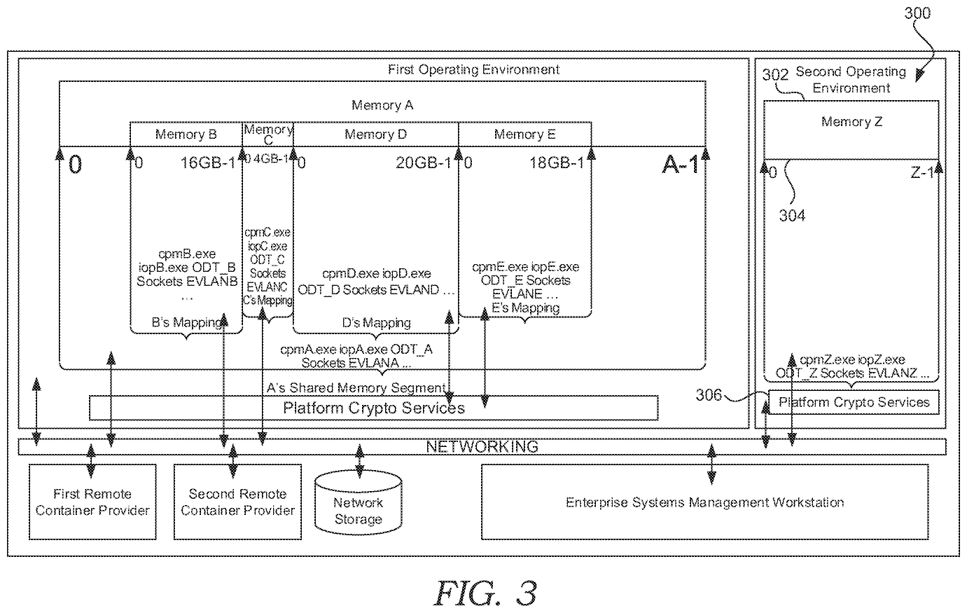

Turning to FIG. 3, another example operating environment, illustrated as second operating environment 300, is shown in addition to first operating environment 200. The second operating environment 300 illustrated in FIG. 3 is one example that may be used as second operating environment 108 of FIG. 1.

Here, second operating environment 300 includes a system architecture, for instance x64, ARM, or the like. Second operating environment 300 may include other RISC, CISC, or other like architectures, such as Power ISA and MIPS, for example. As noted, due to the workload emulation, an advantage of the technology is that first operating environment 200 may have the same type of system architecture as second operating environment 300, or they may be different. For example, first operating environment 200 and second operating environment 300 could each be based on x64 or ARM. In another example, first operating environment 200 is based on x64 and second operating environment 300 is based on ARM, or vice versa.

Second operating environment 300 may also run an operating system such as Windows, Linux, MacOS, BSD, or the like. Similarly, first operating environment 200 and second operating environment 300 may run the same or a different operating system. Second operating environment 300 includes the firmware, e.g., BIOS or UEFI, and include other resources compatible with the operating system.

In the illustrated example of FIG. 3, second operating environment 300 comprises memory Z 302. This may be the primary memory component of second operating environment 300 and may be capable of storing one or more workloads that each provides one or more client services. Memory Z 302 may store a workload within at least a portion of contiguous address range 304, shown extending from 0 to Z−1. In this example, communication are also provided through cryptography services tunnel 306, which may be the same or different from other cryptography services tunnels described herein. In an aspect, each of the one or more workloads may be wholly contained within Memory Z or it may have connections with other entities via networking, named pipes, shared memory areas, etc. which also participate in the workload.

In an aspect, memory Z 302 is included as part of an emulated environment. The emulated environment is responsible for managing additional emulated environments that may include one or more workloads.

As further illustrated in the example, second operating environment 300 may coordinate with other components to provide services via one or more workloads, including via cryptography services tunnel 222 and network 224. Moreover, components of second operating environment 300 may communicate to systems management workstation 226, first remote container server 228, second remote container server 230, and network storage 232.

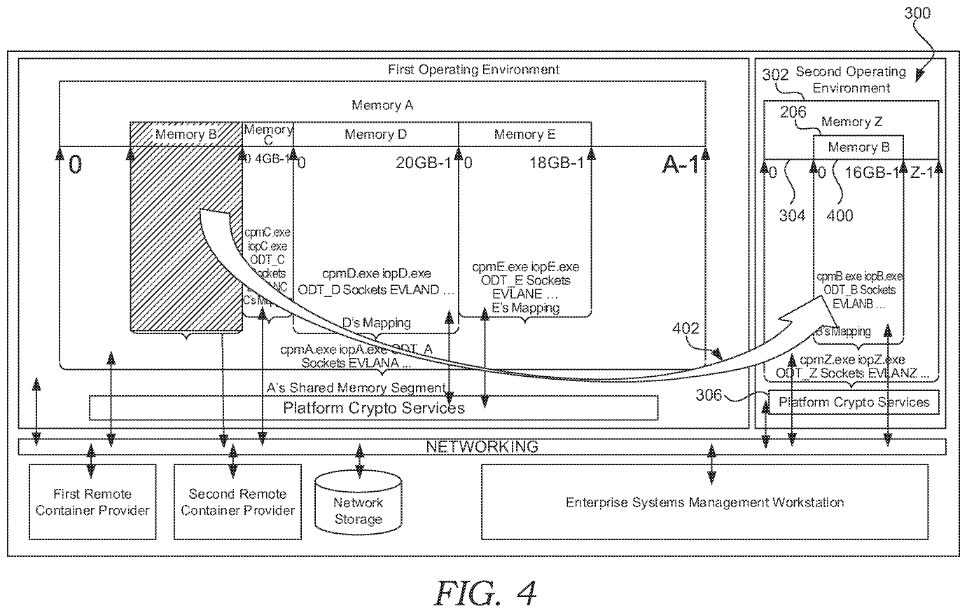

As noted, workload management system 114 of FIG. 1 may be used to move workloads between operating environments, such as first operating environment 104 and second operating environment 108. An example of such is illustrated by FIG. 4, showing first workload 206 being moved from first operating environment 200 to second operating environment 300, as will be further described.

In an aspect, first operating environment 200 is hosted by a first server, and second operating environment 300 is hosted by a different second server. Thus, for instance, the first server hosting first operating environment 200 may be at a first geographical location. The second server hosting second operating environment 300 may be at a second geographical location that is different from the first geographical location. In an implementation that will be further described, workloads may be moved based on the geographical location of the server hosting an operating environment in which the workload will be employed.

Workload management system 114 may move one or more workloads from first operating environment 104 to second operating environment 108 based on a triggering event or other received instruction.

For example, workload management system 114 may move a workload from first operating environment 104 to second operating environment 108 based on a memory capacity of the memory within first operating environment 104. For instance, when a threshold storage capacity is exceeded, workload management system 114 may move a workload from first operating environment 104. The threshold memory capacity may be set at any capacity, examples of which include 75%, 80%, 85%, 90%, 95%, or 100%, or another provided threshold capacity.

In another example, workload management system 114 may move a workload from first operating environment 104 to second operating environment 108 based on a geographical event-that is, a natural or human-caused event, (fire, flood, power outage, etc.) at the location of first server 102 hosting first operating environment 104 may jeopardize the operational ability of first server 102. As such, to continue providing client services via the workload, the workload may be moved to second operating environment 108 hosted by second server 106 that is at a different geographical location.

In another example, workload management system 114 may move a workload from first operating environment 104 to second operating environment 108 based on network capacity. For instance, workload management system 114 may move a workload based on exceeding a network threshold, such as a determined latency, bandwidth, or other like measurement of network traffic. Thus, for instance, workload management system 114 may move a workload to second server 106 where second server 106 is on a network having less network traffic.

In another example, workload management system 114 may move a workload from first operating environment 104 to second operating environment 108 based on power consumption efficiencies. In general, servers consume power when in operation, such as hosting first operating environment 104 having workloads to provide client services. Various power consumption efficiencies may be gained by moving workloads to various servers. For instance, second server 106 may be at a geographical location having greater power access or lower cost of power. Thus, employing a workload at second operating environment 108 hosted by second server 106 relative to first operating environment 104 hosted by first server 102 may provide for efficiencies in power consumed by second server 106 relative to first server 102. Thus, based on the relative power consumption efficiencies between second server 106 at a second geographical location, workload management system 114 may move a workload from first operating environment 104 hosted by first server 102 at a different first geographical location to second operating environment 108.

In another example, workload management system 114 may move a workload from first operating environment 104 to second operating environment 108 based on a move schedule. For instance, the move schedule may identify timeframes at which workloads are to be run at various operating environments, and as such, workload management system 114 may move workloads accordingly. For example, a workload may be performed within first operating environment 104 during a first specified timeframe. At the end of the first specified timeframe, workload management system 114 may move the workload to second operating environment 108 where it is resumed and performed during a second specified timeframe. As an example, this could be done to take advantage of peak network usage times changing based on locations. For instance, there may be less network traffic at midnight in London simultaneously compared to the network traffic at 8:00 AM in Beijing.

In another example, workload management system 114 moves the workload from first operating environment 104 to second operating environment 108 based on a job completion event. That is, based on a particular job being completed by the workload, the workload is then moved to the second operating environment 108 where operations of subsequent jobs are executed by the workload from within the second operating environment 108.

In another example, workload management system 114 moves the workload from first operating environment 104 to second operating environment 108 in advance of an update performed within first server 102 or first operating environment 104, e.g., an update to the software, firmware, or hardware of the system. For instance, in response to receiving an update indication for first server 102 or first operating environment 104, workload management system 114 moves the workload from first operating environment 104 to second operating environment 108. In doing so, first operating environment 104 can be rebooted or otherwise taken offline without corresponding downtime to the client services provided by the workload, as the workload can be moved to and run from second operating environment 108 while first operating environment 104 is updated and rebooted.

These are just some example triggering events that may cause workload management system 114 to move workloads between operating environments. Other triggering events or received instructions may be determined or received by workload management system 114, thus causing workload management system 114 to dynamically move a workload from first operating environment 104 to second operating environment 108.

To move a workload between operating environments, workload management system 114 generally identifies a memory address region within the memory of an operating environment to which a workload is to be moved. Having identified the memory address, the operations of the workload can be quiesced, temporarily pausing the workload and cloning a processor emulator and a bootstrap stack from the workload. The workload can then be replicated at the identified memory address and initiated from the new operating environment using the processor emulator and the bootstrap stack. This example process can be performed by workload management system 114 using memory address identifier 118, workload quiescing engine 120, workload replicator 122, and workload initiator 124.

When moving a workload from first operating environment 104 to second operating environment 108, memory address identifier 118 generally identifies a memory region within the memory of second operating environment 108 to which the workload will be replicated. For example, the workload identified to be moved is stored within the memory of first operating environment 104 over an address region that corresponds to the amount of memory required to store the workload. A starting address location within the memory of second operating environment 108 is identified, and the address region can then include a portion of the contiguous address range corresponding to the amount of memory required by the workload extending from the starting address location.

In anticipation of moving the workload, the workload is quiesced by workload quiescing engine 120 at first operating environment 104. For instance, during quiescing, I/O operations of the workload may be paused. Other operations can be temporarily paused as well, such as scheduling operations. Workload quiescing engine 120 may create a snapshot of the workload and the scheduled operations at the time of the quiescing.

A bootstrap stack may be built from the workload at the first operating environment 104. As noted, in some implementations, workload operations are performed using one or more emulators, referred to as processor emulators. The processor emulator executes, for instance, the I/O operations or other instructions of the workload. The processor emulator specific to the individual workload may be cloned for executing the bootstrap stack. Other components used to execute operations of the workload may be cloned and included within the bootstrap stack.

The processor emulator is that which will execute the instructions streams contained within a memory component. To have an execution environment in the second memory component, the processor emulator (such as an instruction processor or I/O processor) is resident on the platform where the second memory component resides. As such, the processor emulator for the second memory component that is cloned from the processor emulator of the first memory component may not be identical clones. For instance, the cloned processor emulator for the second operating environment is retargeted to operate on an operating environment of the second operating environment that is different from the operating environment of the first operating environment. As an example, the code which is compiled and run to instantiate these modules, may be compiled for a different target processor (e.g. instead of an Intel x64 processor, an ARM family of processor). This capability now allows the workload running in a first memory region (e.g., memory A of FIG. 2), e.g., executing in an x64 environment, to be moved and resumed in another memory region of another operating environment (e.g., memory Z of FIG. 3), e.g., executing in a heterogeneous ARM environment. Essentially, this now allows the underlying engines of the execution environment surrounding the memory environments to be relocated into the future. As new processors are developed and released, if a compiler for the source language of the modules exists for the new processor, then then existing execution environment for the memory components can be instantiated and workloads resumed on the new processors.

In an aspect, the bootstrap stack resides in the memory space of the workload, i.e., the workload being moved from the first operating environment to the second operating environment. It is built by the first operating system, which is instantiated within the first memory of the first operating environment, which in turn schedules and runs the processes which embody the workload. This bootstrap stack may initialize only a portion of memory allocated to the workload. In some aspects, the bootstrap stack does not initialize all memory, as a bootstrap stack may during a normal rebooting process.

The quiesced workload can be replicated within the identified memory region at second operating environment 108 using workload replicator 122. For instance, the workload may be written within the identified address region as copied from the snapshot created during the time when the workload was quiesced. The workload may be replicated with the operations as scheduled at the time of quiescing and may include the bootstrap stack and the cloned processor emulator.

In an aspect, workload replicator 122 may employ a real-time or near real-time replication strategy when moving a workload. To do so, workload replicator 122 can divide memory components into blocks that each include a portion of the contiguous address. In an aspect, the first memory component where a workload is located and the second memory component where a workload is to be moved can be divided into blocks (e.g., first memory component 202 and second memory component 302, respectively). A numerical representation of each block of memory can be generated. For instance, a checksum or other encoding algorithm may be used to generate the numerical representation. The numerical representation for a block of memory in the first memory component is compared to a numerical representation for a corresponding block in the second memory component. If the corresponding block in the second memory component has a different value, then the block of the first memory component is replicated into the corresponding block of the second memory component. As quiescence converges, the write activity, and hence the number of blocks changed per unit time decreases. This is beneficial because it often enables a small residual delta of modified blocks be transferred at relocation time, as the majority of transfer has already occurred.

Workload initiator 124 can be employed to initiate the workload at second operating environment 108 using at least the cloned processor emulator. In doing so, the operations of the workload are resumed. For instance, the I/O operations and other instructions may be resumed according to the scheduler paused during the quiescing. Thus, the client service is provided by the workload when resumed at second operating environment 108.

Advantageously, there is a relatively brief pause of the workload between the quiescing and the workload being resumed, rather than a more lengthy delay associated with traditional methods that may occur due to certain events, such as system maintenance that requires one or more reboots, which can be particularly pronounced when a platform has a large collection of I/O cards that are initialized by the BIOS, sometimes significantly extending the time for even a single reboot. As such, first operating environment 104 may be updated and rebooted after the workload is replicated in the memory of second operating environment 108, during which time client services may be provided by the workload from second operating environment 108.

In an aspect, the workload may be moved back from second operating environment 108 to first operating environment 104 after maintenance, such as updating and rebooting, is performed at first operating environment 104. It will be understood that workloads may be relocated to various memory components within various operating environments. Workloads may be relocated back to the original operating environment, to another operating environment, or may remain at an operating environment until a triggering event or other instruction is determined or received.

FIG. 4 provides an example illustration in which a workload is moved from first operating environment 200 to second operating environment 300. Functions described with respect to workload management system 114 may be performed, for example, by systems management workstation 226 to facilitate movement of first workload 206.

As noted, first workload 206 may provide one or more client services. In the illustrated example, first workload 206 is included as part of a plurality of workloads within first operating environment 200. Here, first workload 206 uses a processor emulator specific to first workload 206, which executes I/O operations or other instructions to provide the client service. As shown, first workload 206 is within address region B 214, which is a portion of contiguous address range A 204 of memory A 202.

Based on a triggering event or other received instruction, an address region within contiguous address range 304 of memory Z 302 may be identified to replicate first workload 206, thereby moving the first workload 206 to second operating environment 300. For instance, memory address identifier 118 may be used to identify address region Z 400 within contiguous address range 304. The identified address region Z 400 may comprise a region that is at least equal the size of the memory allocated to first workload 206 within memory A 202 of first operating environment 200.

First workload 206 may be quiesced using workload quiescing engine 120, pausing I/O operations and other operations that provide the client service. This generates a snapshot of first workload 206. As noted, first workload 206 may have one or more processor emulators, illustrated as cpmB.exe and iopB.exe in the current example. A bootstrap stack is built that includes at least the processor emulator cloned from the first workload processor emulator.

Having quiesced first workload 206, first workload 206 is replicated at address region Z 400 within the second memory component. The snapshot of first workload 206 at the time of quiescing can be replicated using workload replicator 122. Replication of first workload 206 at memory Z 302 is illustrated using arrow 402.

Client services by first workload 206 can be resumed from second operating environment 300. Workload initiator 124 initiates the bootstrap stack using the processor emulator and resumes operations of first workload 206 from memory Z 302 of second operating environment 300.

In an aspect, after replicating first workload 206 within address region Z 400, first operating environment 200, including other components of the system on which first operating environment 200 is hosted, can undergo maintenance, which may include upgrades. This may include updating the hardware, firmware, or software and rebooting first operating environment 200.

First workload 206 may remain operational from within memory Z 302 until another triggering event or other instruction is received to move first workload 206 to another operating environment. In an aspect, this includes moving first workload 206 back to first operating environment 200 after performing maintenance to first operating environment 200. For example, a new address region within another memory component, such as first memory component memory A 202 using memory address identifier 118. First workload 206 can be quiesced using workload quiescing engine 120 to prepare first workload 206 for movement from second operating environment 300. A bootstrap stack can be built and a processor emulator cloned from the processor emulator executing first workload 206 within second operating environment 300. As previously noted, a “cloned” processor emulator includes an exact copy of an existing processor emulator (e.g. the processor emulator of a workload in a first operating environment) in addition to processor emulators that are retargeted to execute in a different operating environment (e.g. the processor emulator of the workload when moved to the second operating environment), often by compiling the cloned processor emulator using a compilier specific to the different operating environment. First workload 206 can be replicated into the new address region of the memory component of the operating environment to which the first workload 206 is moved. When moving back to first operating environment 200, the new address region may be the same address region in which first workload 206 was initially stored, an address region that includes a portion of the same address region in which first workload 206 was initially stored, or an entirely different address region of contiguous address range A 204. Once replicated, operations of first workload 206 can be resumed from the new memory component of the new operating environment, such as memory A 202 of first operating environment 200, in one particular example.

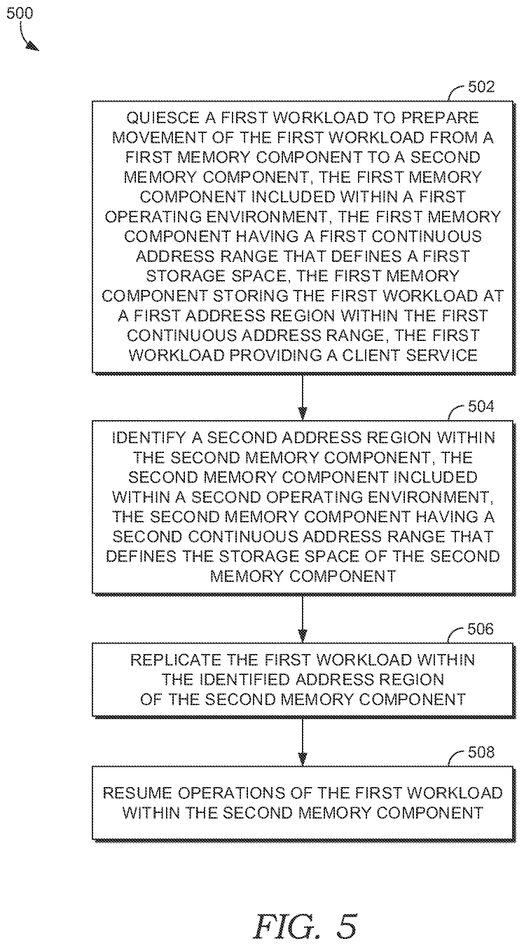

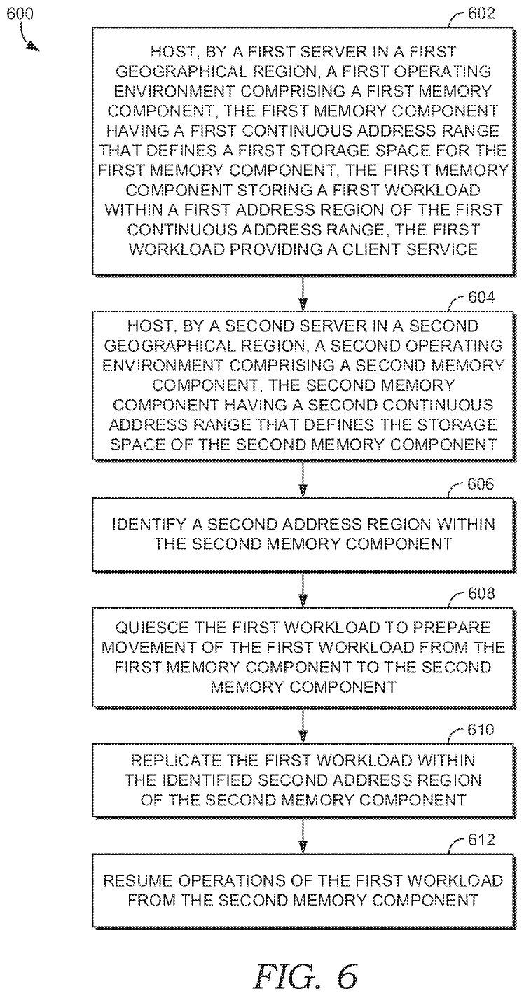

Referring to FIG. 5 and FIG. 6, block diagrams are provided respectively illustrating methods 500 and 600 for moving a workload between operating environments. Each block of the methods may comprise a computing process performed using any combination of hardware, firmware, or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few possibilities. Methods 500 and 600 may be implemented in whole or in part by components of workload management system 114.

Turning to FIG. 5, an example method 500 for moving a workload between operating environments is provided. At block 502, a first workload is quiesced. The first workload may be included as part of a plurality of workloads stored at separate address regions of a contiguous address range of a first memory component within a first operating environment. The first workload is quiesced to prepare the first workload for movement to a second memory component of a second operating environment. In aspects, the first workload is quiesced for movement to the second memory component based on a triggering event or other received instruction. The first operating environment and the second operating environment may run different operating systems on different processors.

At block 504, a second address region is identified within the second memory component. The second address region may be a portion of another contiguous address range of the second memory component. In aspects, the identified address range is adjacent another workload within the second memory component of the second operating environment. In an aspect, a bootstrap stack is built and a processor emulator is cloned from a first workload processor emulator executing the first workload within the first memory component.

At block 506, the first workload is replicated within the identified second address region of the second memory component. The first workload may be replicated from a snapshot of the first workload at the time of the quiescing, including queued I/O operations and other scheduled operations.

At block 508, operations of the first workload are resumed. The operations are resumed from within the second memory component. The operations of the first workload may be provided from the second memory component until another triggering event or other instruction is received to move the first workload. Upon receiving subsequent instructions (e.g., from a triggering event) to move the first workload from the second memory component, the first workload may be moved back to the first memory component or to another memory component.

In an aspect, subsequent to the first workload being replicated at the second memory component and operations resumed, the first operating environment, or server hosting the first operating environment, may undergo maintenance, such as an update to the software, firmware, or hardware, in which the first operating environment is rebooted or otherwise taken offline.

Turning to FIG. 6, an example method 600 for moving a workload between operating environments is provided. In this example, a first workload is moved from a first operating environment to a second operating environment based on the geographical locations of the servers hosting the first and second operating environments, where the first server hosts the first operating environment at a first geographical location, as illustrated at block 602, and the second server hosts the second operating environment at a second geographical location, as illustrated at block 604.

For example, the first workload may be moved to operate at the second server based on power consumption efficiencies provided at the second geographical location of the server relative to the first geographical location of the first server. In another example, the first workload may be moved to operate at the second server based on a measure of the network traffic for the second server at the second geographical location relative to a measure of the network traffic for the first server at the first geographical location. In another example, the first workload may be moved to operate at the second server based on a scheduled timeframe. For instance, operations of the first workload may be performed at the first server during a first specified timeframe. The first workload may be moved to operate at the second server so that the operations of the first workload are performed at the second server during a second specified timeframe.

To move the first workload to operate within a second operating environment hosted by the second server, a second address region within a second memory component may be identified from a contiguous address range of the second memory component, as illustrated at block 606. At block 608, the first workload is quiesced. A processor emulator executing operations of the first workload at the first operating environment may be cloned and a bootstrap stack for initiating operations of the quiesced first workload may be built.

At block 610, the first workload is replicated within the identified second address region. Using at least the cloned processor emulator of the bootstrap stack, at block 612, the operations of the first workload are resumed from within the second operating environment of the second server.

Having described an overview of some embodiments of the present technology, an example computing environment in which embodiments of the present technology may be implemented is described below in order to provide a general context for various aspects of the present technology. Referring now to FIG. 7 in particular, an example operating environment for implementing embodiments of the present technology is shown and designated generally as computing device 700. Computing device 700 is but one example of a suitable computing environment and is not intended to suggest any limitation as to the scope of use or functionality of the technology. Computing device 700 should not be interpreted as having any dependency or requirement relating to any one or combination of components illustrated.

The technology may be described in the general context of computer code or machine-useable instructions, including computer-executable instructions, such as program modules, being executed by a computer or other machine, such as a cellular telephone, personal data assistant or other handheld device. Generally, program modules, including routines, programs, objects, components, data structures, etc., refer to code that performs particular tasks or implements particular abstract data types. The technology may be practiced in a variety of system configurations, including handheld devices, consumer electronics, general-purpose computers, more specialty computing devices, etc. The technology may also be practiced in distributed computing environments where tasks are performed by remote-processing devices that are linked through a communications network.

With reference to FIG. 7, computing device 700 includes bus 702, which directly or indirectly couples the following devices: memory 704, one or more processors 706, one or more presentation components 708, input/output (I/O) ports 710, input/output components 712, and illustrative power supply 714. Bus 702 represents what may be one or more buses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component, such as a display device, to be an I/O component. Also, processors have memory. The inventors recognize that such is the nature of the art, and reiterate that the diagram of FIG. 7 is merely illustrative of an example computing device that can be used in connection with one or more embodiments of the present technology. Distinction is not made between such categories as “workstation,” “server,” “laptop,” “handheld device,” etc., as all are contemplated within the scope of FIG. 7 and with reference to “computing device.”

Computing device 700 typically includes a variety of computer-readable media. Computer-readable media can be any available media that can be accessed by computing device 700 and includes both volatile and non-volatile media, and removable and non-removable media. By way of example, and not limitation, computer-readable media may comprise computer storage media and communication media. Computer storage media, also referred to as a communication component, includes both volatile and non-volatile, removable and non-removable media implemented in any method or technology for storage of information, such as computer-readable instructions, data structures, program modules, or other data. Computer storage media includes, but is not limited to, RAM, ROM, EEPROM, flash memory, or other memory technology; CD-ROM, digital versatile disks (DVDs), or other optical disk storage; magnetic cassettes, magnetic tape, magnetic disk storage, or other magnetic storage devices; or any other medium that can be used to store the desired information and that can be accessed by computing device 700. Computer storage media does not comprise signals per se.

Communication media typically embodies computer-readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, radio frequency (RF), infrared, and other wireless media. Combinations of any of the above should also be included within the scope of computer-readable media.

Memory 704 includes computer storage media in the form of volatile or non-volatile memory. The memory may be removable, non-removable, or a combination thereof. Example hardware devices include solid-state memory, hard drives, optical-disc drives, etc. Computing device 700 includes one or more processors that read data from various entities, such as memory 704 or I/O components 712. Presentation component(s) 708 presents data indications to a user or other device. Example presentation components include a display device, speaker, printing component, vibrating component, etc.

I/O ports 710 allow computing device 700 to be logically coupled to other devices, including I/O components 712, some of which may be built-in. Illustrative components include a microphone, joystick, game pad, satellite dish, scanner, printer, wireless device, etc. The I/O components 712 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition, both on screen and adjacent to the screen, as well as air gestures, head and eye tracking, or touch recognition associated with a display of computing device 700. Computing device 700 may be equipped with depth cameras, such as stereoscopic camera systems, infrared camera systems, RGB (red-green-blue) camera systems, touchscreen technology, other like systems, or combinations of these, for gesture detection and recognition. Additionally, the computing device 700 may be equipped with accelerometers or gyroscopes that enable detection of motion. The output of the accelerometers or gyroscopes may be provided to the display of computing device 700 to render immersive augmented reality or virtual reality. Power supply 714 may be any power supply suitable for computing device 700 or components thereof.

At a low level, hardware processors execute instructions selected from a machine language (also referred to as machine code or native) instruction set for a given processor. The processor recognizes the native instructions and performs corresponding low-level functions relating, for example, to logic, control, and memory operations. Low-level software written in machine code can provide more complex functionality to higher levels of software. As used herein, computer-executable instructions includes any software, including low-level software written in machine code; higher-level software, such as application software; and any combination thereof. Any other variations and combinations thereof are contemplated within embodiments of the present technology.

With reference briefly back to FIG. 1, it is noted and again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of general operating environment 100 can be further described based on the functionality and features of its components. Other arrangements and elements (e.g., machines, interfaces, functions, orders, and groupings of functions, etc.) can be used in addition to or instead of those shown, and some elements may be omitted altogether.

Further, some of the elements described in relation to FIG. 1, such as those described in relation to workload management system 114, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory, such as database 126.

Referring to the drawings and description in general, having identified various components in the present disclosure, it should be understood that any number of components and arrangements might be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described may be implemented as discrete or distributed components or in conjunction with other components, and in any suitable combination and location. Some elements may be omitted altogether. Moreover, various functions described herein as being performed by one or more entities may be carried out by hardware, firmware, or software. For instance, various functions may be carried out by a processor executing instructions stored in memory. As such, other arrangements and elements (e.g., machines, interfaces, functions, orders, and groupings of functions, etc.) can be used in addition to or instead of those shown.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including,” “having,” and other like words and their derivatives have the same broad meaning as the word “comprising,” and the word “accessing” comprises “receiving,” “referencing,” or “retrieving,” or derivatives thereof. Further, the word “communicating” has the same broad meaning as the word “receiving” or “transmitting,” as facilitated by software or hardware-based buses, receivers, or transmitters using communication media described herein.

In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment. However, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to the distributed data object management system and the schematics described herein, it is understood that the techniques described may be extended to other implementation contexts.

From the foregoing, it will be seen that this technology is one well-adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated by the accompanying drawings is to be interpreted as illustrative and not in a limiting sense.

Some example aspects that can be practiced from the foregoing description include the following:

Aspect 1: A computerized method comprising: employing a first operating environment comprising a first memory component, the first memory component having a first contiguous address range that defines a first storage space for the first memory component, the first memory component storing a plurality of workloads, each workload stored in a separate address region within the first contiguous address range and providing a client service; employing a second operating environment comprising a second memory component, the second memory component having a second contiguous address range that defines the storage space of the second memory component; identifying an address region within the second memory component; quiescing a first workload of the plurality of workloads to prepare movement of the first workload from the first memory component to the second memory component; replicating the first workload within the identified address region of the second memory component; and resuming operations of the first workload from the second memory component.

Aspect 2: A system comprising: at least one processor; and one or more computer storage media storing computer-readable instructions thereon that when executed by the at least one processor cause the at least one processor to perform operations comprising: quiescing a first workload to prepare movement of the first workload from a first memory component to a second memory component, the first memory component included within a first operating environment, the first memory component having a first contiguous address range that defines a first storage space, the first memory component storing a plurality of workloads, each workload stored in a separate address region within the first contiguous address range and providing a client service; identifying an address region within the second memory component, the second memory component included within a second operating environment, the second memory component having a second contiguous address range that defines the storage space of the second memory component; replicating the first workload within the identified address region of the second memory component; and resuming operations of the first workload from the second memory component.

Aspect 3: One or more computer storage media storing computer-readable instructions thereon that, when executed by a processor, cause the processor to perform operations comprising: quiescing a first workload to prepare movement of the first workload from a first memory component to a second memory component, the first memory component included within a first operating environment, the first memory component having a first contiguous address range that defines a first storage space, the first memory component storing the first workload at a first address region within the first contiguous address range, the first workload providing a client service; identifying a second address region within the second memory component, the second memory component included within a second operating environment, the second memory component having a second contiguous address range that defines the storage space of the second memory component; replicating the first workload within the identified address region of the second memory component; and resuming operations of the first workload from the second memory component.

Aspect 4: A method comprising: hosting, by a first server in a first geographical region, a first operating environment comprising a first memory component, the first memory component having a first contiguous address range that defines a first storage space for the first memory component, the first memory component storing a first workload within a first address region of the first contiguous address range, the first workload providing a client service; hosting, by a second server in a second geographical region, a second operating environment comprising a second memory component, the second memory component having a second contiguous address range that defines the storage space of the second memory component; identifying a second address region within the second memory component; quiescing the first workload to prepare movement of the first workload from the first memory component to the second memory component; replicating the first workload within the identified second address region of the second memory component; and resuming operations of the first workload from the second memory component.

Aspect 5: Aspect 4, wherein operations of the first workload are resumed at the second server in the second geographical location based on power consumption efficiencies provided at the second geographical location.

Aspect 6: Any of Aspects 4-5, wherein operations of the first workload are resumed at the second server in the second geographical location based on a measure of network traffic during at the second geographical location.

Aspect 7: Any of Aspects 4-6, wherein operations of the first workload performed at the first server during a first specified timeframe and the operations of the first workload are resumed at the second server at a second specified timeframe.

Aspect 8: Any of Aspects 1-7, further comprising, from the first workload, building a bootstrap stack and cloning at least a processor emulator from a first workload processor emulator executing the first workload within the first memory component, wherein the operations of the first workload are resumed from within the second memory component using the processor emulator and the bootstrap stack.

Aspect 9: Any of Aspects 1-8, after replicating the first workload within the identified address region of the second memory component, updating and rebooting the first operating environment.

Aspect 10: Aspect 9, further comprising: identifying a new address region within the first memory component; quiescing the first workload to prepare movement of the first workload from the second memory component to the first memory component; replicating the first workload within the identified new address region of the first memory component, the first workload being replicated within the new address region after updating and rebooting the first operating environment; and resuming operations of the first workload from the first memory component.

Aspect 11: Any of Aspects 1-10, wherein the first operating environment and the second operating environment implement different operating system architectures.

Aspect 12: Any of Aspects 1-11, wherein resuming the operations of the first workload from the second memory component comprises resuming I/O (input/output) operations paused when quiescing the first workload.

Aspect 13: Any of Aspects 1-12, wherein the address region within the second memory component is identified based on a memory size of an address region within the first memory component occupied by the first workload.

What is claimed is:

1. A computerized method comprising:
employing a first operating environment comprising a first memory component, the first memory component having a first contiguous address range that defines a first storage space for the first memory component, the first memory component storing a plurality of workloads, each workload stored in a separate address region within the first contiguous address range and providing a client service;
employing a second operating environment comprising a second memory component, the second memory component having a second contiguous address range that defines the storage space of the second memory component;
identifying an address region within the second memory component;
quiescing a first workload of the plurality of workloads to prepare movement of the first workload from the first memory component to the second memory component;
replicating the first workload within the identified address region of the second memory component; and
resuming operations of the first workload from the second memory component.

2. The computerized method of claim 1, further comprising, from the first workload, building a bootstrap stack and cloning at least a processor emulator from a first workload processor emulator executing the first workload within the first memory component, wherein the operations of the first workload are resumed from within the second memory component using the processor emulator and the bootstrap stack.

3. The computerized method of claim 1, after replicating the first workload within the identified address region of the second memory component, updating and rebooting the first operating environment.

4. The computerized method of claim 3, further comprising:
identifying a new address region within the first memory component;
quiescing the first workload to prepare movement of the first workload from the second memory component to the first memory component;
replicating the first workload within the identified new address region of the first memory component, the first workload being replicated within the new address region after updating and rebooting the first operating environment; and
resuming operations of the first workload from the first memory component.

5. The computerized method of claim 1, wherein the first operating environment and the second operating environment implement different operating system architectures.

6. The computerized method of claim 1, wherein resuming the operations of the first workload from the second memory component comprises resuming I/O (input/output) operations paused when quiescing the first workload.

7. The computerized method of claim 1, wherein the address region within the second memory component is identified based on a memory size of an address region within the first memory component occupied by the first workload.

8. A system comprising:
at least one processor; and
one or more computer storage media storing computer-readable instructions thereon that when executed by the at least one processor cause the at least one processor to perform operations comprising:
quiescing a first workload to prepare movement of the first workload from a first memory component to a second memory component, the first memory component included within a first operating environment, the first memory component having a first contiguous address range that defines a first storage space, the first memory component storing a plurality of workloads, each workload stored in a separate address region within the first contiguous address range and providing a client service;
identifying an address region within the second memory component, the second memory component included within a second operating environment, the second memory component having a second contiguous address range that defines the storage space of the second memory component;
replicating the first workload within the identified address region of the second memory component; and
resuming operations of the first workload from the second memory component.

9. The system of claim 8, further comprising, from the first workload, building a bootstrap stack and cloning at least a processor emulator from a first workload processor emulator executing the first workload within the first memory component, wherein the operations of the first workload are resumed from within the second memory component using the processor emulator and the bootstrap stack.

10. The system of claim 8, after replicating the first workload within the identified address region of the second memory component, updating and rebooting the first operating environment.

11. The system of claim 10, further comprising:
identifying a new address region within the first memory component;
quiescing the first workload to prepare movement of the first workload from the second memory component to the first memory component;
replicating the first workload within the identified new address region of the first memory component, the first workload being replicated within the new address region after updating and rebooting the first operating environment; and
resuming operations of the first workload from the first memory component.

12. The system of claim 8, wherein the first operating environment and the second operating environment implement different operating system architectures.

13. The system of claim 8, wherein resuming the operations of the first workload from the second memory component comprises resuming I/O (input/output) operations paused when quiescing the first workload.

14. The system of claim 8, wherein the address region within the second memory component is identified based on a memory size of an address region within the first memory component occupied by the first workload.

15. One or more computer storage media storing computer-readable instructions thereon that, when executed by a processor, cause the processor to perform operations comprising:
quiescing a first workload to prepare movement of the first workload from a first memory component to a second memory component, the first memory component included within a first operating environment, the first memory component having a first contiguous address range that defines a first storage space, the first memory component storing the first workload at a first address region within the first contiguous address range, the first workload providing a client service;
identifying a second address region within the second memory component, the second memory component included within a second operating environment, the second memory component having a second contiguous address range that defines the storage space of the second memory component;
replicating the first workload within the identified address region of the second memory component; and
resuming operations of the first workload from the second memory component.

16. The media of claim 15, further comprising, from the first workload, building a bootstrap stack and cloning at least a processor emulator from a first workload processor emulator executing the first workload within the first memory component, wherein the operations of the first workload are resumed from within the second memory component using the processor emulator and the bootstrap stack.

17. The media of claim 15, after replicating the first workload within the identified second address region of the second memory component, updating and rebooting the first operating environment.

18. The media of claim 17, further comprising:
identifying a new address region within the first memory component;
quiescing the first workload to prepare movement of the first workload from the second memory component to the first memory component;
replicating the first workload within the identified new address region of the first memory component, the first workload being replicated within the new address region after updating and rebooting the first operating environment; and
resuming operations of the first workload from the first memory component.

19. The media of claim 15, wherein the first operating environment and the second operating environment implement different operating system architectures.

20. The media of claim 15, wherein resuming the operations of the first workload from the second memory component comprises resuming I/O (input/output) operations paused when quiescing the first workload.
